(19) United States
(12) Patent Application Publication
(10) Pub. No.: US 2005/0026511 A1
(43) Pub. Date: Feb. 3, 2005

(54) Seats for fastening electrical contacts in battery compartment

(75) Inventor: Tsung-Yao Wu, Taipei Hsien (TW)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei Hsien (TW)

(21) Appl. No.: 10/627,810

(22) Filed: Jul. 28, 2003

(51) Int. Cl. H01R 13/40

(52) U.S. Cl. 439/733.1

(57) ABSTRACT

A seat device for fastening electrical contacts in a battery. The device includes, an integral housing having first openings inside, a second opening on a surface thereof, and a well formed thereon having a portion in communication with the first openings and the remaining portion in communication with the second opening and at least one cell groove. At least one seat provided at one end of the cell groove adjacent to the first openings includes an indentation distal from the cell groove in communication with inside of the seat. An inclined protrusion, and an L-shaped recess are adjacent to the indentation, for fastening the electrical contacts in the seat.

### FIELD OF THE INVENTION

The present invention relates to fastening electrical contacts in a battery compartment and more particularly to an improved seat mechanism for fastening electrical contacts in a battery compartment of an electronic device.

### BACKGROUND OF THE INVENTION

Now we are living in an information age. All kinds of high technology and communication products are invented due to the fast progress in electronics and associated technology. The fast development and mass production of the new products not only bring much convenience to human beings, but also are very closely related to our daily life. In response to all kinds of new electronic products being developed, especially consumer's electronic products, most users become more critical with respect to the convenience in using them. Thus, whether consumer's electronic products produced in the future can provide a more convenient and effective characteristic will be an indicator to decide whether sales of one major electronics company are much easier than that of other major electronics companies.

Moreover, high technology companies have to not only maintain good product quality but also increase its production for meeting the needs of vast consumers about electronic products. In other words, each manufacturing process whether important or not will contribute much to the increase of production. In a typical example, a fast fastening of an electrical contact in a battery compartment is an important factor in the increase of production in a manufacturing process of electronic products. Also, a good fastening of the electrical contact means that it is difficult of disengaging the electrical contact from the battery compartment and thus a good quality is ensured. There is a fierce competition among electronics companies. Thus, one electronics company may be eliminated from the market and by other competitive electronics companies if their production is low, product quality is poor, and sales are dull in the market.

Conventional seats mounted in a battery compartment are shown in FIG. 1 in conjunction with FIGS. 5A and 5B. At least one cell groove 10 is provided in a housing 1 for fastening an electrical contact (e.g., flat coil spring (FIG. 5A) or three-dimensional helical spring (FIG. 5B)) 3. A seat 11 is provided at either end of the cell groove 10. The seat 11 comprises an indentation 110 distal from the cell groove 10. The indentation 110 is in communication with inside of the seat 11. The seat 11 further comprises an inclined protrusion 111 obliquely projected away from the indentation 110. The inclined protrusion 111 has a predetermined length so that the electrical contact 3 can be fastened in the seat 11 by the inclined protrusion 111 when the electrical contact 3 is appropriately inserted in the indentation 110.

However, as shown in FIGS. 1, 5A, and 5B, the typical electrical contact 3 is formed of a metal conductor which is extended helically to form a coil or helical body 30 and an elongate extension 31 having a predetermined length. As seen from the above, the typical electrical contact 3 has its body 30 placed in the seat 11 and fastened by the inclined protrusion 111 and its extension 31 placed in a cavity 112 in the seat 11. The metal electrical contact 3 has a predetermined elasticity because it is bent. However, the extension 31 in the cavity 112 is not fastened. Hence, the extension 31 tends to clear the cavity 112 due to vibration or collision in a delivery process. This is a significant drawback of the typical electrical contact 3. Also, it contradicts low cost, high efficiency and mass production principles adopted by modern industry. Thus, the need for improvement still exists.

### SUMMARY OF THE INVENTION

A primary object of the present invention is to provide a seat mechanism for fastening electrical contacts in a battery compartment. The seat mechanism comprises an integral housing, a plurality of first openings inside the housing, a second opening on a surface of the housing, a well formed on the housing, the well including a portion corresponding to the first openings and being in communication therewith, the remaining portion corresponding to the second opening and being in communication therewith, and at least one cell groove, a seat at one end of the cell groove adjacent to the first openings, the seat including an indentation at one end thereof distal from the cell groove, the indentation being in communication with inside of the seat, an inclined protrusion in the seat, and an L-shaped recess at one side of the seat adjacent to the indentation. Also, each of the electrical contacts is extended to form a body and an elongate extension so that the body is fastened in the seat by the inclined protrusion when the body is inserted through the indentation into the first seat and the extension is fastened at the L-shaped recess, thereby fastening the whole electrical contact in the seat. By utilizing the present invention, the above drawbacks of the prior art can be overcome. These drawbacks are that the typical electrical contact has its body placed in the seat and fastened by the inclined protrusion and its extension placed in a cavity in the seat. But the extension is not fastened since the electrical contact is formed of metal conductor and is bent to possess a predetermined elasticity. Hence, the extension tends to clear the cavity due to vibration or collision in a delivery process.

The above and other objects, features and advantages of the present invention will become apparent from the following detailed description taken with the accompanying drawings.

### BRIEF DESCRIPTION OF THE DRAWINGS

FIG. 1 is a perspective view of a battery compartment having conventional seats for fastening electrical contacts;

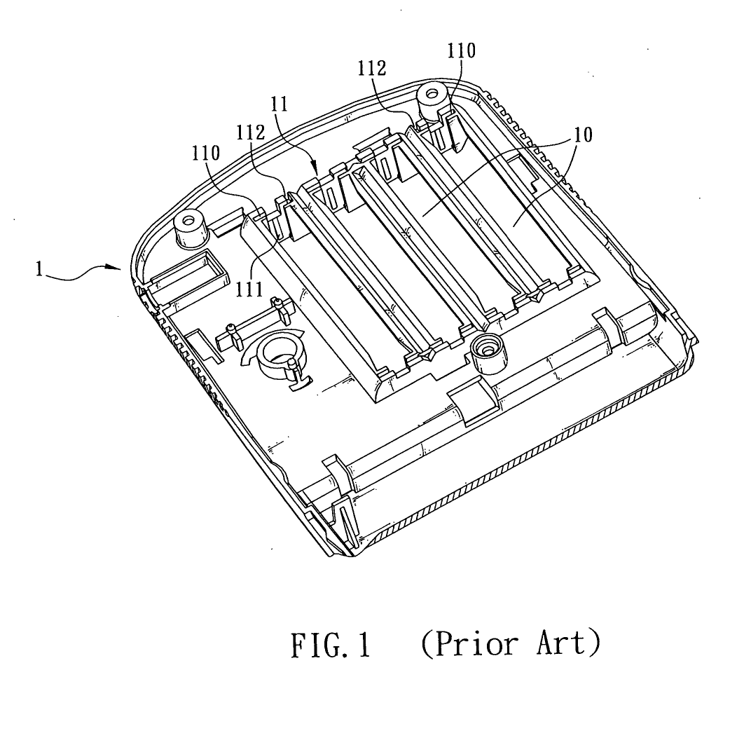

FIG. 2 is a perspective view of an electronic product having its battery compartment open to show seats for fastening electrical contacts according to the invention;

FIG. 3 is a perspective view of the electronic product with the housing removed to show interior details of the battery compartment and other components;

FIG. 4 is an enlarged perspective view of the seat of the invention; and

FIGS. 5A and 5B are perspective views of two types of electrical contacts used in the prior art.

### DETAILED DESCRIPTION OF THE PREFERRED EMBODIMENTS

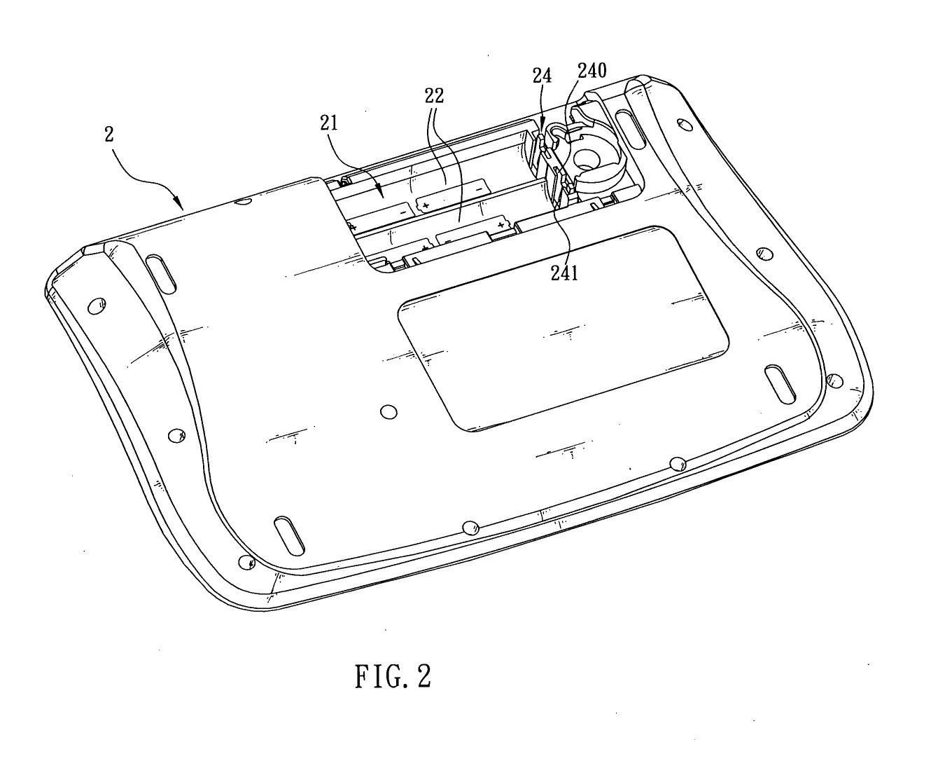

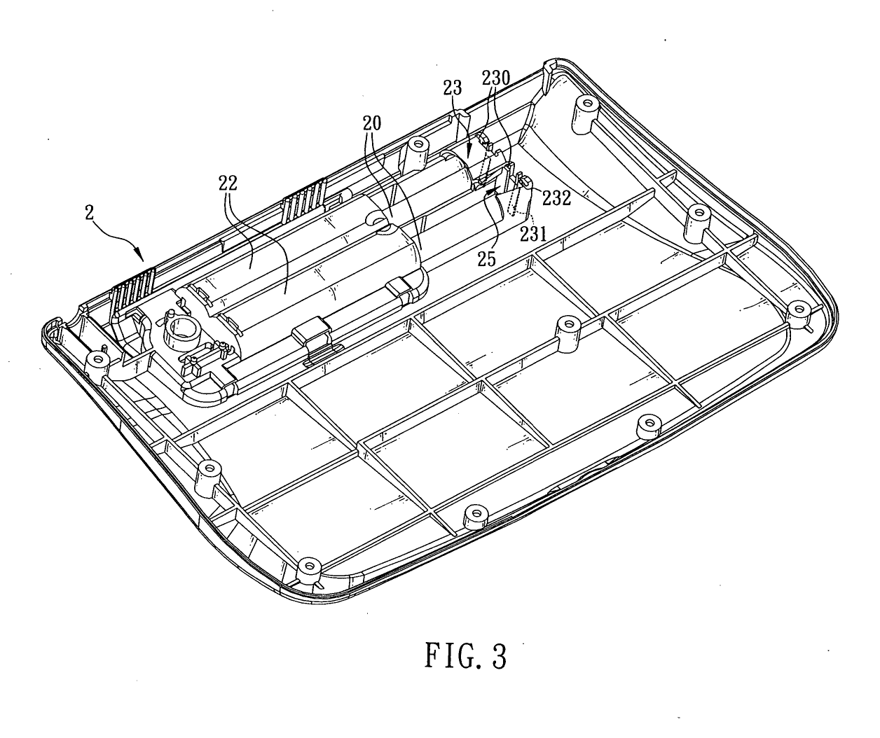

Referring to FIGS. 2 and 3, a seat mechanism for fastening electrical contacts in a battery compartment of an electronic device in accordance with the invention is shown. The electronic product comprises an integral housing 2. A plurality of first openings 20 are formed inside the housing 2 and a second opening 21 is formed on the surface of the housing 2. A well is formed on the housing 2 in which a portion of the well corresponds to the first openings 20 and is in communication therewith and the remaining portion of the well corresponds to the second opening 21 and is in communication therewith. At least one cell groove 22 is provided in the well so that a plurality of cells may install sequentially in the cell groove 22 by passing the second opening 21.

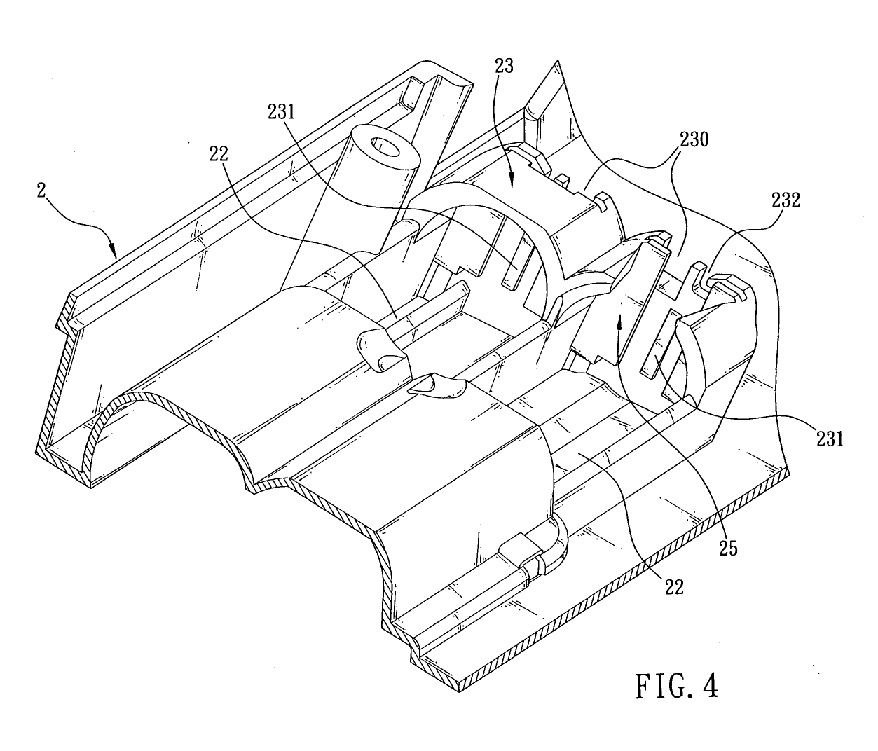

Referring to FIGS. 3 and 4, a first seat 23 is provided at one end of the cell groove 22 adjacent to the first openings 20. The first seat 23 comprises a first indentation 230 at one end thereof distal from the cell groove 22. The first indentation 230 is in communication with inside of the first seat 23. The first seat 23 further comprises a first inclined protrusion 231 obliquely projected away from the first indentation 230. The first inclined protrusion 231 has a predetermined length. The first seat 23 further comprises an L-shaped recess 232 at one side of the first seat 23 adjacent to the first indentation 230.

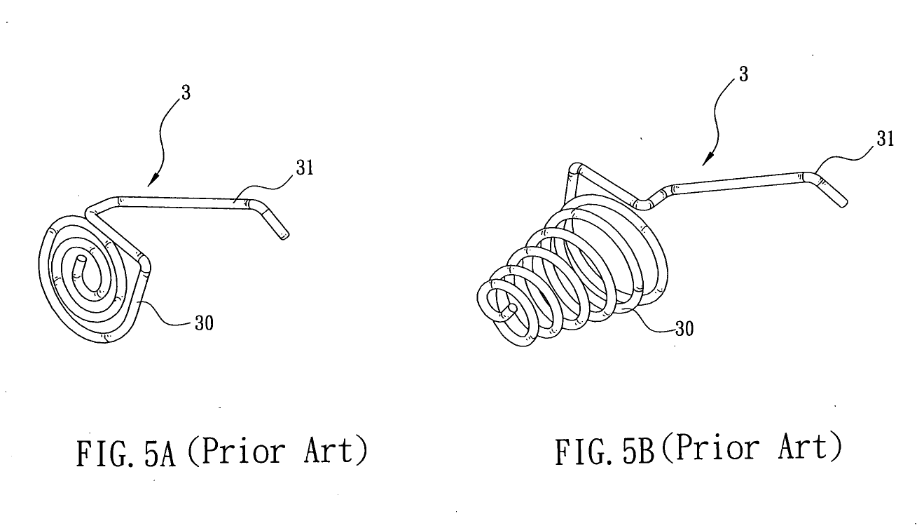

Referring to FIGS. 4, 5A, and 5B, an electrical contact 3 formed of metal conductor is extended helically to form a coil or helical body 30 and an elongate extension 31 having a predetermined length extended away from the body 30. As stated above, the first inclined protrusion 231 is obliquely projected away from the first indentation 230. As such, the body 30 can be fastened in the first seat 23 by the first inclined protrusion 231 when the body 30 is inserted through the first indentation 230 into the first seat 23. Also, the extension 231 projected from the first seat 23 is placed in the L-shaped recess 232. The L-shaped recess 232 comprises a vertical hole and a horizontal hole in communication with the vertical hole. Thus, the extension 31 is fastened at one end of the the horizontal hole by its elasticity after has been inserted through the vertical hole into the horizontal hole.

Referring to FIGS. 2, 3, 3, 5A, and 5B, by configuring as above, the whole electrical contact 3 (including the body 30 and the extension 31) is secured to the first seat 23. This is a significant improvement with respect to the prior art which only fastened the body 30 rather than the extension 31. As such, the electrical contact 3 will not disengage from its fastened position due to vibration or collision in a delivery process. This is an advantageous benefit of the invention.

Referring to FIG. 2, in the invention a second seat 24 is provided at the other end of the cell groove 22 adjacent to the second opening 21. The second seat 24 comprises a second indentation 240 at one end thereof distal from the cell groove 22. The second indentation 240 is in communication with inside of the second seat 24. The second seat 24 further comprises a second inclined protrusion 241 obliquely projected away from the second indentation 240. The second inclined protrusion 241 has a predetermined length.

Referring to FIGS. 5A and 5B, the electrical contact 3 is implemented either in a three-dimensional helical spring (FIG. 5B) as a negative terminal or a flat coil spring (FIG. 5A) as a positive terminal.

Referring to FIGS. 3 and 4, in the invention for mounting the three-dimensional helical spring in the first seat 23 two recessed members 25 are formed in the cell groove 22. The recessed members 25 are coupled to the first seat 23. As such, it facilitates mounting the three-dimensional helical spring in the first seat 23.

Referring to FIGS. 3 and 4, in the invention the cell grooves 22 are formed in a plural form. Also, the cell grooves 22 are parallel in the well. Further, the recessed members 25 are provided in each of the cell grooves 22 and are spaced apart from first seat 23.

While the invention has been described by means of specific embodiments, numerous modifications and variations could be made thereto by those skilled in the art without departing from the scope and spirit of the invention set forth in the claims.

1. A seat mechanism for fastening electrical contacts in
a battery compartment, comprising:
an integral housing;
a plurality of first openings inside the housing;
a second opening on a surface of the housing;
a well formed on the housing, the well including a first portion corresponding to the first openings and being in communication therewith, and a second portion corresponding to the second opening and being in communication therewith, and at least one cell groove so that a plurality of cells can be installed sequentially in the cell groove by passing through the second opening;
at least one first seat and one end of the cell groove adjacent to the first openings, the first seat including a first indentation at one end thereof and distal from the cell groove, the first indentation being in communication with inside of the first seat so that one of a plurality of electrical contacts can be fastened in the first seat by the first indentation;
at least one first inclined protrusion in the first seat, the first inclined protrusion being obliquely projected away from the first indentation and having a predetermined length; and
at least one L-shaped recess at one side of the first seat adjacent to the first indentation, the L-shaped recess including a vertical hole and a horizontal hole in communication with the vertical hole.

2. The seat mechanism of claim 1, wherein each of the electrical contacts is formed of metal conductor and is extended helically to form a body and an elongate extension having a predetermined length extended away from the body so that the body is fastened in the first seat by the first inclined protrusion when the body is inserted through the first indentation into the first seat and the extension is fastened at one end of the horizontal hole by its elasticity after being inserted through the vertical hole into the horizontal hole, thereby fastening the electrical contact in the first seat.

3. The seat mechanism of claim 1, further comprising a second seat at another end of the cell groove adjacent to the second opening, the second seat including a second indentation at one end thereof distal from the cell groove, the second indentation being in communication with inside of the second set, a second inclined protrusion obliquely projected away from the second indentation, and the second inclined protrusion having a predetermined length.

4. The seat mechanism of claim 2, wherein each of the electrical contact is a three-dimensional helical spring.

5. The seat mechanism of claim 2, wherein each of the electrical contacts is a flat coil spring.

6. The seat mechanism of claim 4, further comprising two recessed members at both sides of the first seat so as to facilitate mounting the three-dimensional helical spring in the first seat.

7. The seat mechanism of claim 6, wherein the cell grooves are formed in a plural form and are parallel in the well and the recessed members are disposed in each of the cell grooves and are spaced apart from first seat.
